(19) United States
(12) Patent Application Publication
(10) Pub. No.: US 2024/0097440 A1
(43) Pub. Date: Mar. 21, 2024

(54) Chain of Power Devices

(71) Applicant: Solaredge Technologies Ltd., Herzeliya (IL)

(72) Inventors: Ilan Yoscovich, Givatayim (IL); Tzachi Glovinsky, Petah Tikva (IL); Ofir Bieber, Ra'anana (IL)

(21) Appl. No.: 18/511,655

(22) Filed: Nov. 16, 2023

Related U.S. Application Data
(63) Continuation of application No. 17/500,102, filed on Oct. 13, 2021, now Pat. No. 11,870,250.
Application No. 17/500,102 is a continuation of application No. 15/478,526, filed on Apr. 4, 2017, now Pat. No. 11,177,663.
(60) Provisional application No. 62/395,461, filed on Sep. 16, 2016.
(60) Provisional application No. 62/341,147, filed on May 25, 2016.
(60) Provisional application No. 62/318,303, filed on Apr. 5, 2016.

(51) Int. Cl. H02J 1/12; H01R 4/00; H01R 25/00; H02J 3/38; H02J 3/46; H02S 40/32; H02S 40/34; H02S 40/36; H02S 50/00; H02S 50/10

(52) U.S. Cl. CPC H02J 1/12; H01R 4/00; H01R 25/00; H02J 3/38; H02J 3/381; H02J 3/388; H02J 3/46; H02S 40/32; H02S 40/34; H02S 40/36; H02S 50/00; H02S 50/10; H02J 1/00

(57) ABSTRACT

Various implementations described herein are directed to methods for connecting power devices prior to deployment in a photovoltaic installation, for cost savings and easy deployment. Some embodiments disclosed herein include manufacturing a chain of power devices already coupled by conductors, and providing a mechanical assembly for convenient storage and deployment.

### CROSS REFERENCE TO RELATED APPLICATIONS

This application is a continuation of U.S. application Ser. No. 17/500,102, filed Oct. 13, 2021, which is a continuation of U.S. application Ser. No. 15/478,526, filed Apr. 4, 2017, now U.S. Pat. No. 11,177,663, which claims benefit of U.S. Provisional Patent Application No. 62/318,303, filed Apr. 5, 2016, U.S. Provisional Patent Application No. 62/341,147, filed May 25, 2016, and U.S. Provisional Patent Application No. 62/395,461, filed Sep. 16, 2016, the contents of which are incorporated herein by reference in their entireties for all purposes.

### BACKGROUND

Power devices may be electrically coupled to photovoltaic (PV) generators and configured the set the operating point of the generators to generate maximum power. They may also be coupled to power production and/or storage units such as batteries, wind or hydroelectric turbines and the like.

Power devices are often manufactured, packaged and sold as single units, leading to deployment which requires that each device be individually coupled to its power unit and the devices themselves coupled by connecting electric cables between them.

Accordingly, there is a need for power device systems in which costs, time and complexity in deploying the power devices are reduced.

### SUMMARY

The following summary is a short summary of some of the inventive concepts for illustrative purposes only, and is not intended to limit or constrain the inventions and examples in the detailed description. One skilled in the art will recognize other novel combinations and features from the detailed description.

Embodiments herein may employ a string of photovoltaic power devices (e.g. DC/DC converters, DC/AC inverters, measuring and monitoring devices) which may be deployed in photovoltaic installations. In some embodiments discussed herein, conductors may be used to couple power devices to one another during manufacturing to form a chain of power devices, with the chain packaged and sold as a single unit. The chain may be deployed by coupling the power devices in the chain to photovoltaic (PV) generators (e.g. one or more photovoltaic cells, substrings, PV panels, strings of PV panels and/or PV shingles). The coupling of power devices at the time of manufacturing may reduce costs and enable compact storage of the devices, and the easy deployment may reduce installation time. Connecting power devices at the time of manufacturing may include directly connecting conductors (e.g. by soldering or screwing the conductors into place within a power device enclosure) between adjacent power devices. Furthermore, preconnecting power device may reduce the number of connectors (e.g. MC4™ connectors) featured in each power device from four (two connectors for connecting to a PV generator at the power device input and two connectors for connecting between power devices at the power device output). As connectors may be costly components, substantial savings may be realized. Additionally, preconnecting power devices during manufacturing may increase system safety. For example, if improperly connected, connection points between power devices may be susceptible to overheating, arcing and/or other unsafe event which may result in fire. Preconnecting power devices during manufacturing without use of connectors may increase system safety by reducing the number of connection points from four per power device to two per power device.

Certain embodiments of illustrative power-circuit chains may be wound around a storage spool similar to spools used for storing electrical cables, and deployed in photovoltaic installations by unrolling the spool and coupling the power devices to photovoltaic generators the power devices unwound from the spool.

In some embodiments of illustrative power-circuit chains, a distance between adjacent power devices may correspond to an estimated distance between photovoltaic generator junction boxes in a photovoltaic installation, to enable adjacent power devices to be coupled to adjacent photovoltaic generators. In some embodiments, more than one photovoltaic generator may be coupled to each power device. For example, in some solar installations, two PV generators may be coupled in series and the two generators may then be coupled to one power device, in which case the length between adjacent power devices may be about double the distance between adjacent generators.

The photovoltaic power devices may include, but are not limited to, DC/DC converters, DC/AC inverters, devices configured to measure and monitor photovoltaic parameters, communication devices, safety devices (e.g., fuses, circuit breakers and Residual Current Detectors) and/or Maximum Power Point Tracking (MPPT) devices. The power generation units may include, but are not limited to, photovoltaic modules (e.g. photovoltaic cells, photovoltaic generators), batteries, wind turbines, hydroelectric turbines and fuel cells.

As noted above, this Summary is merely a summary of some of the features described herein and is provided to introduce a selection of concepts in a simplified form that are further described below in the Detailed Description. The Summary is not exhaustive, is not intended to identify key features or essential features of the claimed subject matter and is not to be a limitation on the claims.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures. A more complete understanding of the present disclosure and the advantages thereof may be acquired by referring to the following description in consideration of the accompanying drawings, in which like reference numbers indicate like features, and wherein:

FIGS. 1A-1E are part schematic, part block diagrams of illustrative photovoltaic systems according to certain embodiments.

FIGS. 2A-2C depict photovoltaic power devices according to certain embodiments.

FIG. 3 is part schematic, part block diagram depicting a photovoltaic power device according to certain embodiments.

FIGS. 4A-4C depict illustrative embodiments of strings of photovoltaic power devices coupled by conductors.

FIGS. 5A-5C depict illustrative embodiments of portions of photovoltaic strings, with a plurality of photovoltaic power devices coupled to each other by conductors and coupled to photovoltaic generators.

FIG. 6 depicts an illustrative embodiment of a string of photovoltaic power devices coupled by conductors, stored on a storage device.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made, without departing from the scope of the present disclosure.

Since power devices may often be used in bulk (e.g., one power device per photovoltaic generator may be used in a solar installation including multiple photovoltaic strings, each string including ten, twenty or more photovoltaic generators), costs may be reduced and deployment may be easier by packaging power devices in a form which enables multiple devices to be strung out and deployed at one time, along a photovoltaic string. Furthermore, use of a storage device such as a spool to wind multiple cable-connected devices around can make storage and deployment easier and cheaper.

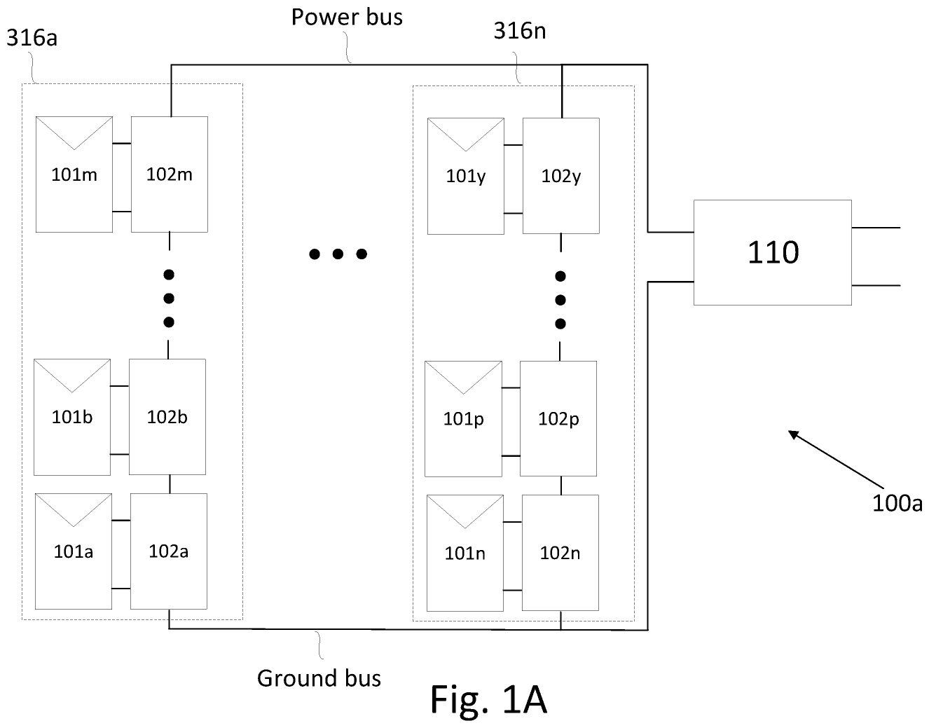

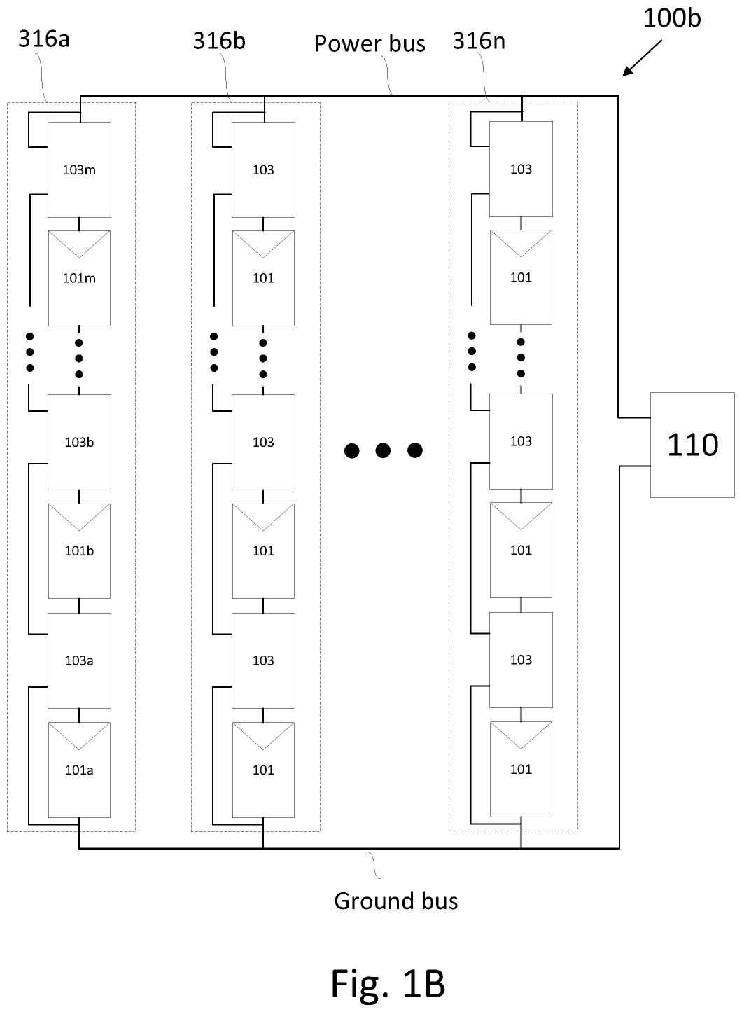

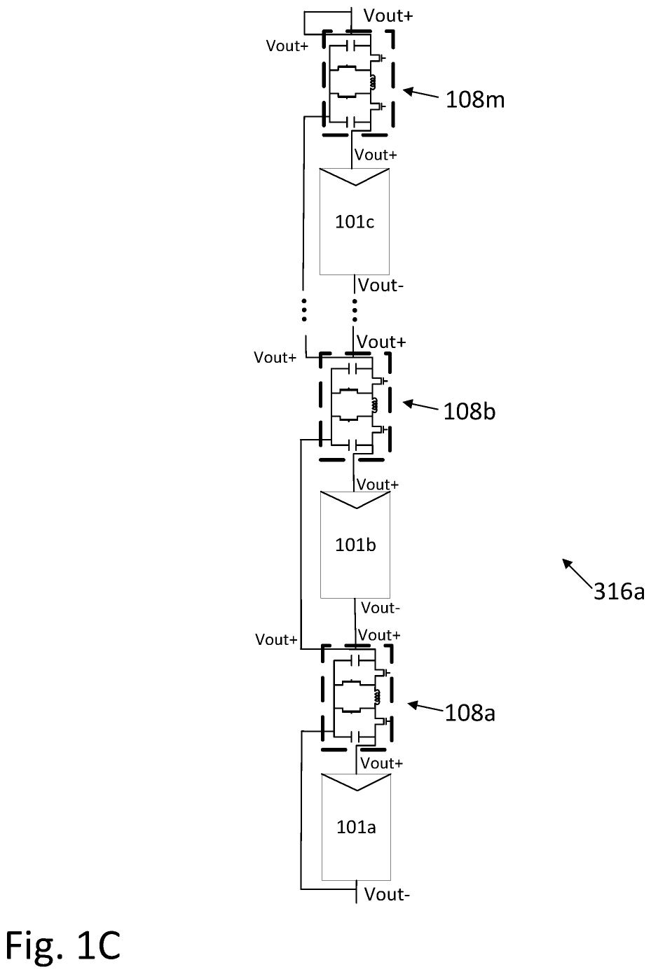

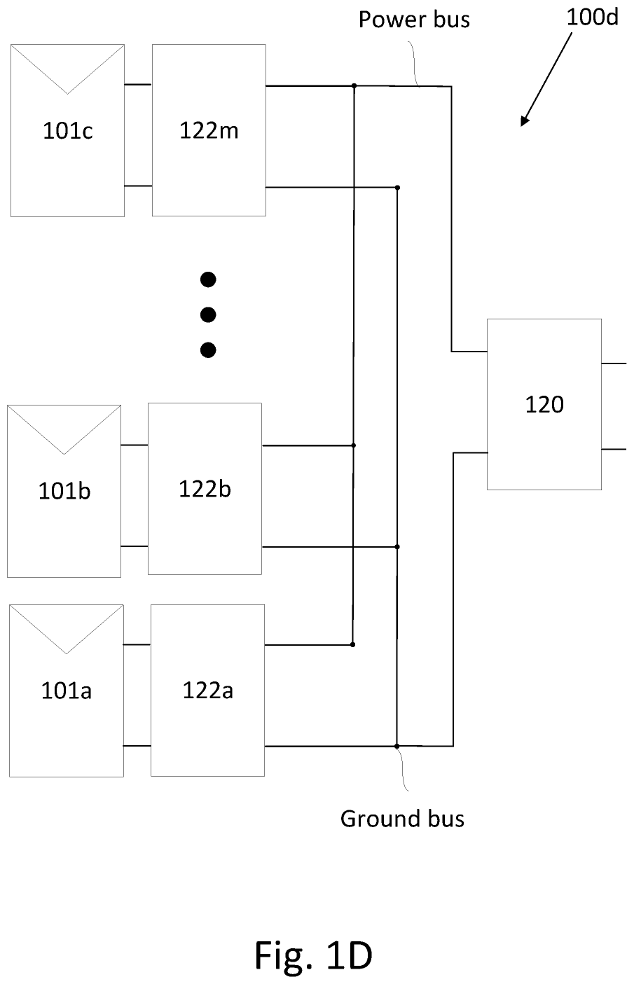

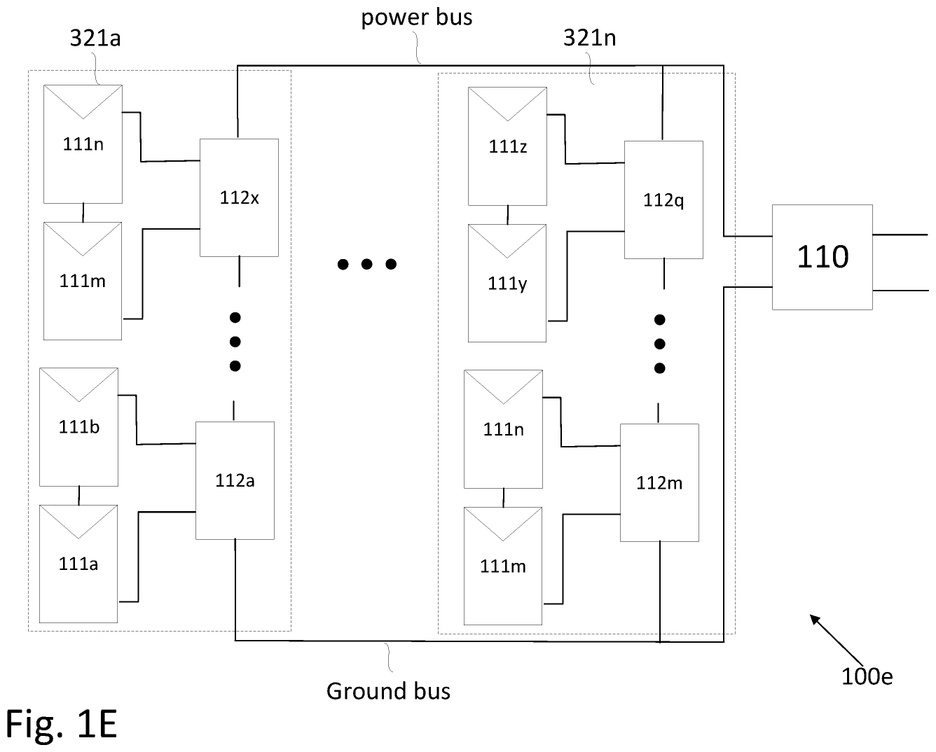

Referring to FIG. 1A, illustrative photovoltaic installation 100a may include a plurality of photovoltaic (PV) modules 101a-y. Photovoltaic generators may also be referred to as “photovoltaic modules”. Each PV generator 101a-y may be coupled to a photovoltaic power device 102a-y.

In some embodiments, one or more PV power device 102a-y may comprise a power conversion circuit such as a direct current—direct current (DC/DC) converter such as a buck, boost, buck-boost, flyback and/or forward converter. In some embodiments, one or more PV power device 102a-y may comprise a direct current—alternating current (DC/AC) converter, also known as an inverter or a microinverter. In some embodiments, one or more PV power device 102a-y may include a Maximum Power Point Tracking (MPPT) and/or Impedance Matching circuit with a controller, configured to extract regulated (e.g. increased) power from the PV generator the power device is coupled to. One or more PV power device 102a-y may further comprise a control device such as a microprocessor, Digital Signal Processor (DSP) and/or a field-programmable gate array (FPGA). In some embodiments, one or more PV power device 102a-y may comprise circuitry and/or sensors configured to measure parameters on or near the photovoltaic generator, such as the voltage and/or current output by the generator, the power output by the generator, the irradiance received by the generator and/or the temperature on or near the generator.

In the illustrative embodiment depicted in FIG. 1A, a plurality of PV power devices 102a-m are coupled in series, to form a first photovoltaic string 316a. One terminal of the resultant photovoltaic string 316a may be coupled to a power bus, and the other terminal of the photovoltaic string 316a may be coupled to a ground bus. In some embodiments, the power and ground buses may be input to system power device 110. System power device 110 may comprise a DC/AC converter, and the DC/AC converter may output AC power to the grid, home or other destinations. In some embodiments, the photovoltaic power devices may comprise microinverters, and an additional inverter (e.g. part of system power device 110) may not be included. In some embodiments, the power devices may output a time-varying DC signal which emulates a rectified sine wave, in which case system power device 110 may comprise a full-bridge circuit configured to convert the rectified sine wave to a standard, alternating sine wave. In some embodiments, system power device 110 may include a combiner box for combining power from a plurality of photovoltaic strings (e.g. 316a-316n). In some embodiments, system power device 110 may comprise sensors/sensor interfaces for measuring or receiving measurements of one or more parameters (e.g. current, voltage, power, temperature etc.) associated with PV strings 316a-316n. In some embodiments, system power device 110 may include one or more safety switches for disconnecting and/or short-circuiting PV strings 316a-316n in case of a potentially unsafe condition or in response to a manual trigger (e.g. activating a rapid-shutdown switch or button).

Since PV power devices of known systems may be generally manufactured, packaged and sold separately, PV installations which include a plurality of PV generators, e.g., installation 100a may require unpacking a large number of devices, individually coupling each device to its corresponding photovoltaic generator, and then coupling the power devices to one another using cables which may be sold separately as well. In some embodiments introduced herein, a power device chain is provided. The power device chain may include a plurality of power devices each coupled to at least one other power device using conductors of appropriate length at the time of manufacturing. Accordingly, power device chains as described herein may be packaged and sold as a single unit, and deployed as a single unit when installing installation 100a. For example, power devices 102a-m may comprise a string of power devices or part of a string of power devices, and may be coupled to one another during manufacturing. During installation, the string may simply be strung out alongside photovoltaic modules 101a-m and each device may be coupled to its corresponding module quickly and easily, forming photovoltaic string 316a.

As shown in FIG. 1A, installation 100a may include a plurality of photovoltaic strings 316a-n, with a terminal of each photovoltaic string 316a-n being coupled to the power bus and the other terminal being coupled to the ground bus.

Referring now to FIG. 1B, illustrative system 100b may share many of the same

characteristics as illustrative installation 100a of FIG. 1A, but the wiring of photovoltaic strings may differ in some respects. For example, in illustrative system 100b, each photovoltaic power device 103a-m may be coupled to two photovoltaic generators. For example, photovoltaic power device 103a may be coupled to generators 101a and 101b, power device 103b may be coupled to generators 101b and 101c (not shown), and so on. Wiring each photovoltaic string (e.g. 316a) in this manner may save money by requiring thinner and fewer cables to couple the power devices to the generators and to one another.

In the illustrative embodiment show in FIG. 1B, the power devices may be pre-coupled to one another during manufacturing, packaged and/or sold together, and deployed easily, similar to as described with reference to installation 100a shown in FIG. 1A. For effective system operation and for easy and fast coupling of the power devices to the photovoltaic generator(s) the power devices are meant to be coupled to, the electrical and/or mechanical design of the power devices used for systems such as 100a may differ from the design used for systems such as 100b. The pre-coupling, packaging and easy deployment described herein may be applied to different kinds of power devices used in different kinds of photovoltaic systems, regardless of mechanical design and electrical topology details which may be specific to certain power devices.

Reference is now made to FIG. 1C, which shows an illustrative embodiment of a photovoltaic string 316a in which each photovoltaic power device is coupled to two photovoltaic modules. In this embodiment, PV power devices 108a-m comprise Buck-Boost DC/DC converters. Additional circuitry may be included in power devices 108a-m, but is not explicitly depicted in FIG. 1C. Additional circuitry and/or wiring configurations may be used to couple power devices to photovoltaic generators according to various aspects of the present disclosure.

Referring to FIG. 1D, illustrative embodiments may include photovoltaic

installation 100d, comprising a plurality of photovoltaic generators 101a-m each coupled to a power device 122a-m. Each power device may have two outputs, one coupled to a mutual power bus, and one coupled to a mutual ground bus, coupling all the power devices in parallel. In some embodiments, one or more power device 122a-m may comprise a DC/DC converter, with each converter's positive output coupled to the power bus, and the negative terminal coupled to the ground bus. In some embodiments, one or more power device 122a-m may comprise a DC/AC converter, with the AC outputs synchronized to allow parallel coupling. In some embodiments including an AC output by the power devices, the AC output may be a single phase coupled to the power and ground buses, and in some embodiments three or more phases may be output to more than two buses. The system may further include the power bus and ground bus being input to grid-coupling device 120. In embodiments including a DC output by the power devices, grid coupling device 120 may include a DC/AC inverter. In embodiments including an AC output by the power devices, grid coupling device 120 may include a transformer. Grid coupling device 120 may be similar to or the same as system power device 110 of FIG. 1A, and may comprise safety devices (e.g. sensors, circuit breakers, fuses, etc.) and/or control and/or monitoring devices.

Referring to FIG. 1E, more than one photovoltaic module may be coupled to each

photovoltaic power device. System 100e includes two photovoltaic modules (e.g. photovoltaic panels or a different type of photovoltaic generator) 111a, 111b coupled to each other in series, with a photovoltaic power device 112a coupled in parallel to the serially coupled modules 111a, 111b. Similar to other embodiments disclosed herein, a plurality of power devices 112a-x may be coupled in series to form a photovoltaic string 321a, with multiple strings 321a-n coupled in parallel between the ground and power buses. In some embodiments, inverter 123 may receive a DC input from the ground and power buses and output AC power to the grid or home. In similar embodiments, the power devices may be precoupled to one another at the time of manufacturing, with the conductors coupling the power devices being sized to allow the desired number of photovoltaic generators to be coupled to each power device. For example, if each two PV generators are to be coupled to one another and to a single power device, the length of each conductor between power devices being around double the width or length of each photovoltaic module.

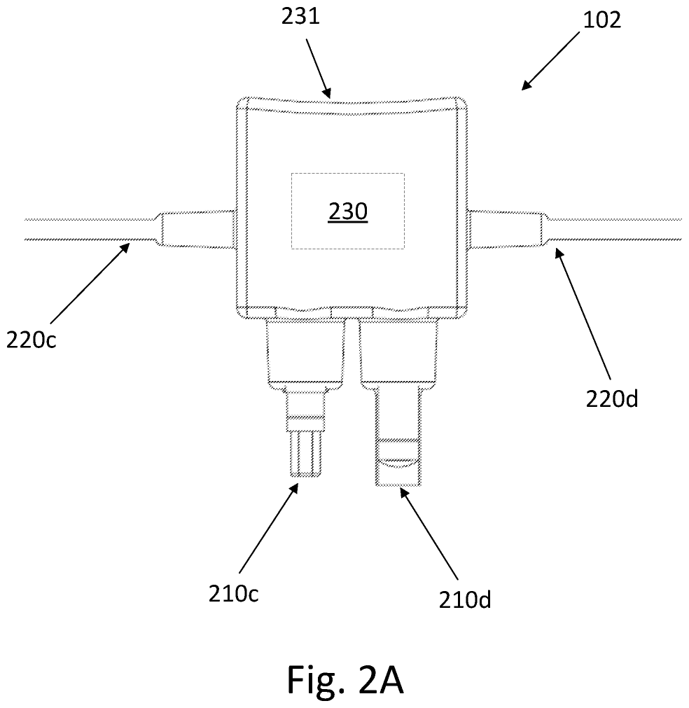

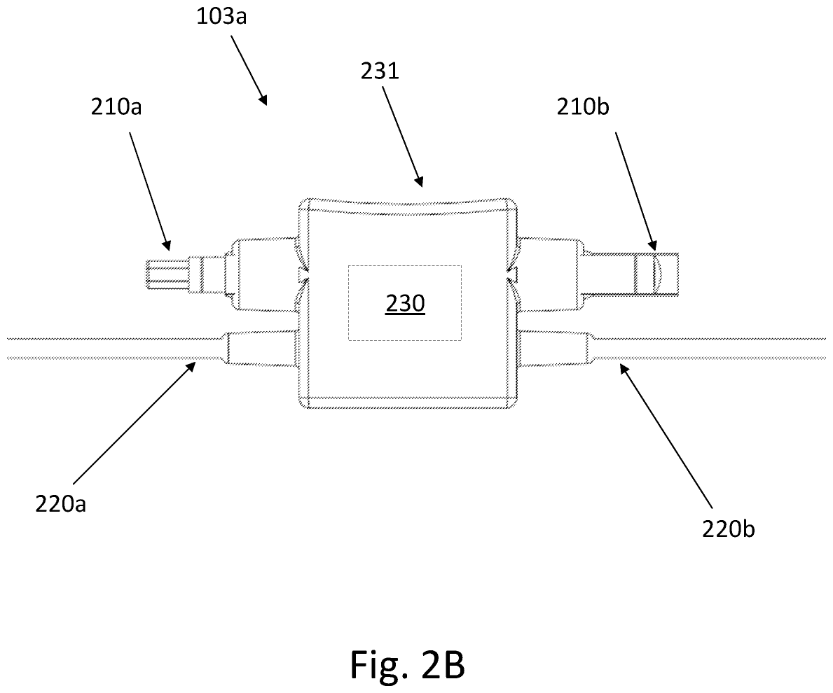

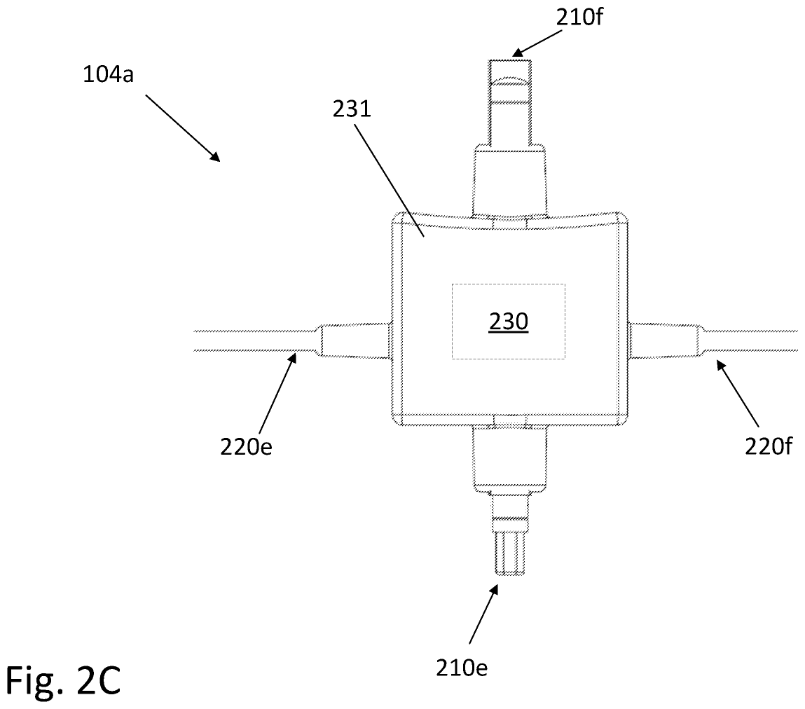

Referring to FIG. 2A, photovoltaic power device 102 may be configured in

various ways. In one illustrative embodiment, photovoltaic power device 102 may comprise a casing 231 containing circuitry 230, input terminals 210c and 210d, and output conductors 220c and 220d. In other embodiments, casing 231 may be replaced by a surface on which circuitry 230 is mounted, the surface being snapped to a different part of a photovoltaic apparatus such as a junction box. In some embodiments, there may be more than two input terminals. For example, some embodiments may include four input terminals for coupling the power device to two photovoltaic modules, the power device processing power input from both modules.

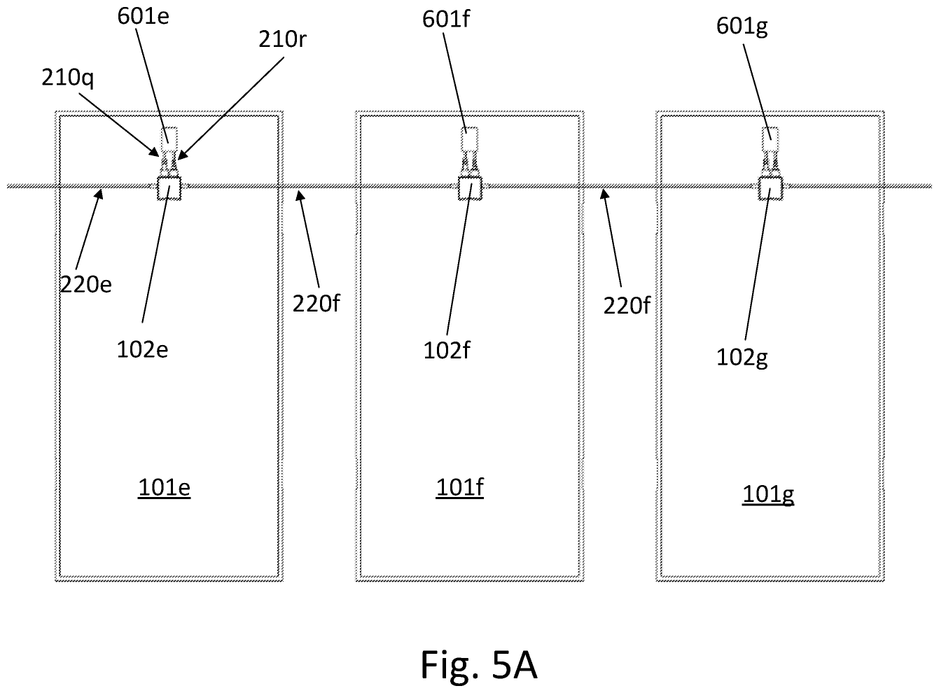

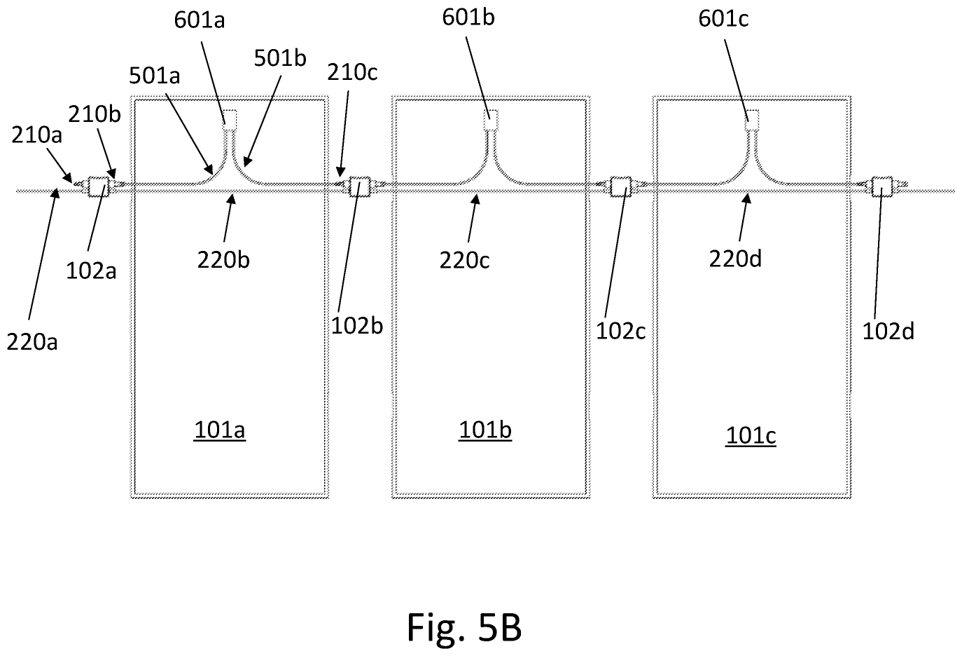

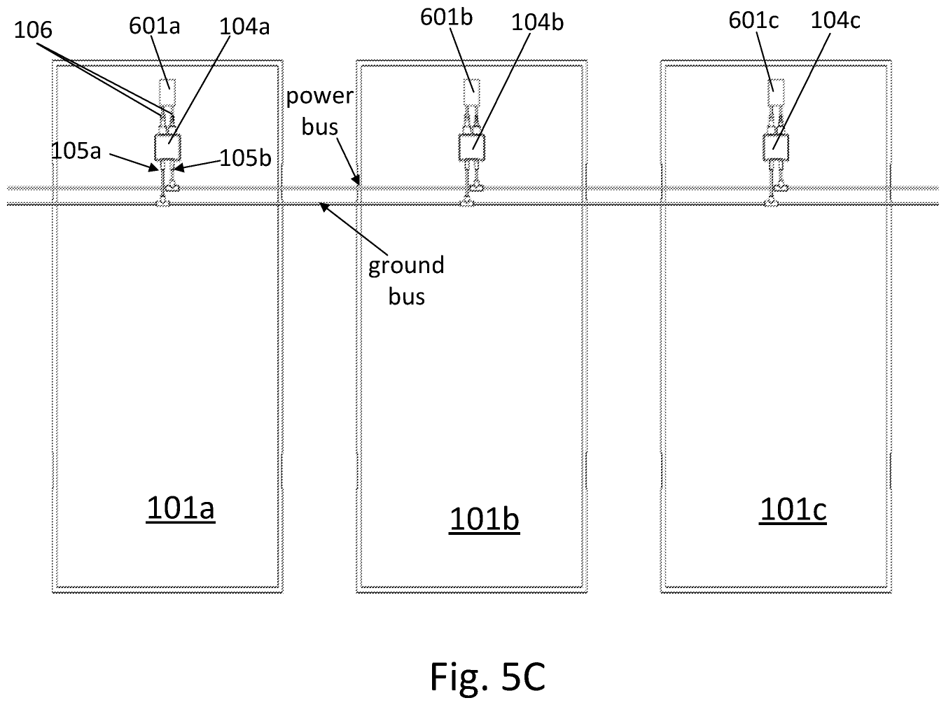

In some embodiments, circuitry 230 may include a power conversion circuit such as a direct current—direct current (DC/DC) converter such as a buck, boost, buck-boost, Cuk, charge pump, flyback and/or forward converter. In some embodiments, circuitry 230 may include a direct current—alternating current (DC/AC) converter, also known as an inverter or a microinverter. In some embodiments, circuitry 230 may include a Maximum Power Point Tracking (MPPT) circuit with a controller, configured to extract increased power from the PV generator the power device is coupled to. Circuitry 230 may further comprise a control device such as a microprocessor, Digital Signal Processor (DSP) and/or an FPGA. In some embodiments, circuitry 230 may include circuitry and/or sensors configured to measure parameters on or near the photovoltaic generator, such as the voltage and/or current output by the generator, the power output by the generator, the irradiance received by the generator and/or the temperature on or near the generator. Input terminals 210c and 210d may be coupled to outputs of one or more photovoltaic modules, and may also be coupled to circuitry 230 for processing and/or measuring the power output by the corresponding photovoltaic module. Output conductors 220c and 220d may couple the photovoltaic power device to adjacent devices, to form a serial or parallel photovoltaic string. The input and output terminals may be physically connected to different parts of casing 231. The input terminals 210c and 210d may be physically located next to one another along one side of casing 231, with output conductors 220c and 220d occupying opposite sides of casing 231, on either side of input terminals 210c and 210d. In other embodiments, the input terminals and output conductors may be configured differently, as will be shown herein. The location of the input terminals and output conductors may be chosen considering the layout and wiring design of the system at hand. Mechanical considerations, such as enabling optimal storing of the entire chain of power devices, may also factor into designing the location of the input terminals and output conductors. The photovoltaic power device 102 shown in FIG. 2A may be particularly suited for coupling to a single photovoltaic generator (in systems such as those shown in FIGS. 1A and 5A), since the input terminals are next to each other, though photovoltaic power device 102 may also be deployed in a way that couples it to two generators.

Referring now to FIG. 2B, the input terminals and output conductors may be

configured such that input terminal 210a is adjacent to output conductor 220a, both connected to a side of casing 231, and on the opposite side of casing 231 input terminal 210b is adjacent to output conductor 220b. This illustrative embodiment may be particularly suited for coupling photovoltaic power device 103a to two photovoltaic generators (in systems such as those shown in FIGS. 1B and 5B), since the two input terminals may be coupled to two generators on either side of the power device, though photovoltaic power device 103a may also be deployed in a way that couples it to a single generator.

Referring now to FIG. 2C, the input terminals and output conductors may be

configured such that input terminals 210e and 210f are located on opposing sides of casing 231, while output conductors 220e and 220f are located on the other pair of opposite sides of casing. Thus, four sides of the casing contain either an input terminal or an output conductor. This illustrative embodiment may, in some configurations, enable optimal packaging of the chain of power devices and enable it to be stored in a compact convenient way. The chain according this embodiment can be deployed in a way that couples each power device to either one or two photovoltaic modules.

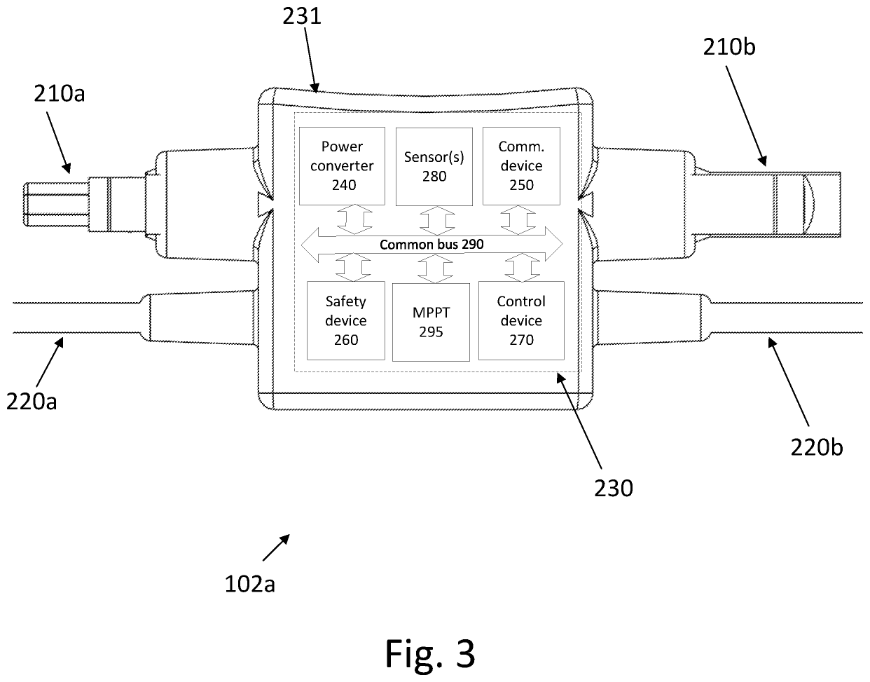

Referring now to FIG. 3, the casing 231 may house circuitry 230. In some

embodiments, circuitry 230 may include power converter 240. Power converter 240 may include a direct current-direct current (DC/DC) converter such as a buck, boost, buck-boost, flyback and/or forward converter. In some embodiments, power converter 240 may include a direct current—alternating current (DC/AC) converter, also known as an inverter or a microinverter. In some embodiments, circuitry 230 may include Maximum Power Point Tracking (MPPT) circuit 295, configured to extract increased power from the PV generator the power device is coupled to. In some embodiments, power converter 240 may include MPPT functionality, and MPPT circuit 295 may not be included. Circuitry 230 may further comprise control device 270 such as a microprocessor, Digital Signal Processor (DSP) and/or an FPGA. Control device 270 may control and/or communicate with other elements of circuitry 230 over common bus 290. In some embodiments, circuitry 230 may include circuitry and/or sensors 280 configured to measure parameters on or near the photovoltaic generator, such as the voltage and/or current output by the generator, the power output by the generator, the irradiance received by the generator and/or the temperature on or near the generator. In some embodiments, circuitry 230 may include communication device 250, configured to transmit and/or receive data and/or commands from other devices. Communication device 250 may communicate using Power Line Communication (PLC) technology, or wireless technologies such as ZigBee, Wi-Fi, cellular communication or other wireless methods. In some embodiments, PLC signals may be transmitted and/or received over output conductors 220a and/or 220b. In some embodiments, a communications link (e.g. an optical fiber) may be integrated with output conductors 220a and/or 220b and may be communicatively coupled to communication device 250. In some embodiments, a thermal sensor device (e.g. a thermocouple device or a Linear Heat Detector) may be integrated with output conductors 220a and 220b and may provide temperature measurements (e.g. measurements obtained at various locations along output conductors 220a and 220b) to control device 270. Input terminals 210a and 210b may be coupled to outputs of one or more photovoltaic modules, and may also be coupled to circuitry 230 for processing and/or measuring the power output by the corresponding photovoltaic module. In some embodiments, circuitry 230 may include safety devices 260 (e.g. fuses, circuit breakers and Residual Current Detectors). The various components of circuitry 230 may communicate and/or share data over common bus 290.

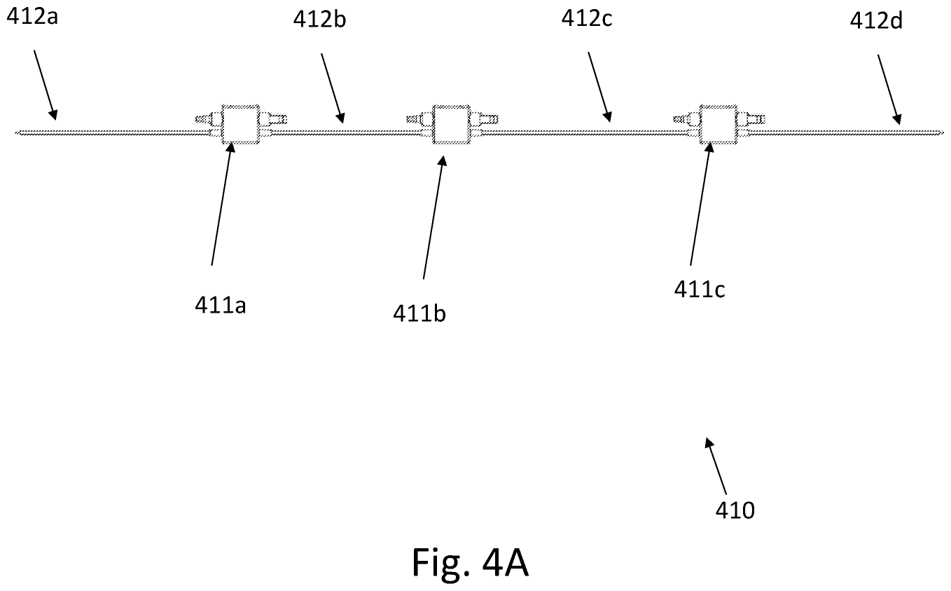

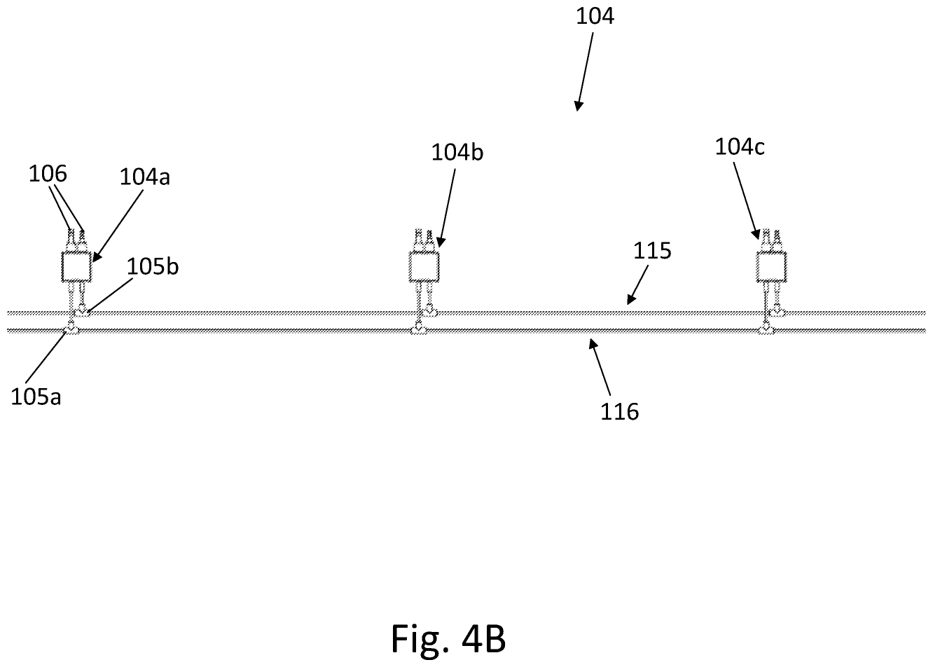

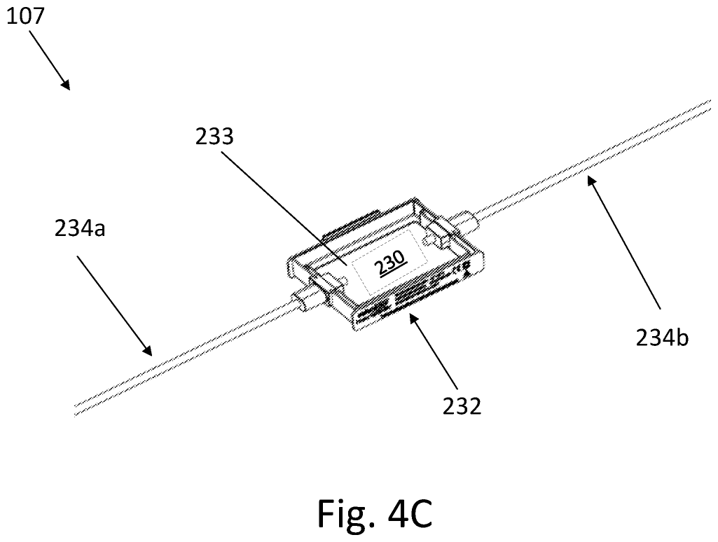

FIG. 4A depicts an illustrative embodiment of chain 410. Chain 410 may comprise plurality of photovoltaic power devices 411a-c coupled by plurality of conductors 412a-d. In some embodiments, a chain of photovoltaic power devices similar to chain 410 may comprise ten, twenty or even a hundred photovoltaic power devices. In some embodiments, chain 410 may be manufactured and/or sold as a single unit. Photovoltaic power devices 411a-c may be similar to or the same as photovoltaic power devices described herein, for example, photovoltaic power device 102 of FIG. 2A, or photovoltaic power device 103a of FIG. 2B. Conductors 412a-d may be directly coupled (e.g. connected) to the output terminals of a DC/DC converter or DC/AC inverter included in a photovoltaic power device (e.g. 411a-c). The length of each output conductor 412a-d may be appropriate to enable each PV power device to be coupled to photovoltaic generators in a photovoltaic string. Since different PV generators may have different dimensions, and since the PV generators may be oriented differently during deployment, the distance between power devices (i.e., the length of each output conductor) may vary in different chains. However, many PV generators (e.g. PV panels) are of similar dimensions, and PV panels are generally oriented in one of two ways (vertically, aka “portrait”, or horizontally, aka “landscape”), so a chain of photovoltaic power devices (e.g. chain 410) featuring a standard distance between power devices may be deployed many photovoltaic systems. For example, photovoltaic panels are generally manufactured in standard sizes, such as around 65 by around 39 inches for residential installations or around 77 by around 39 inches for commercial installations. Therefore, chains of power devices configured to be deployed with panels of dimensions similar to those cited above may include conductors which are around 39, around 65 or around 77 inches long. While the input terminals and output conductors 412a-d of illustrative power devices 411a-c denoted in FIG. 4A are located similarly to what is shown in FIG. 2B, this does not rule out embodiments in which the input terminals and output conductors are located similarly to what is shown in FIG. 2A, or various other configurations without departing from the scope of the present disclosure.

Conductors 412a-412d may be (e.g. during manufacturing or chain 410) internally connected to circuitry (e.g. circuitry 230 of FIG. 3) inside photovoltaic power devices 411a-411c at the time of manufacturing. For example, conductor 412b may, at a first end, be soldered or connected via a screw to a power converter or monitoring device in photovoltaic power device 411a, and at a second end, be soldered or connected via a screw to a power converter or monitoring device in photovoltaic power device 411b. Preconnecting conductors between power devices may reduce the number of connectors (e.g. MC4™ connectors) featured in each power device from four (two connectors for connecting to a PV generator at the power device input and two connectors for connecting between power devices at the power device output). As connectors may be costly components, substantial savings may be realized. Additionally, preconnecting power devices during manufacturing may increase system safety. For example, if improperly connected, connection points between power devices may be susceptible to overheating, arcing and/or other unsafe event which may result in fire. Preconnecting conductors between power devices during manufacturing without use of connectors may increase system safety by reducing the number of connection points from four per power device to two per power device.

Referring now to FIG. 4B, a chain of photovoltaic power devices 104 may

comprise output conductors which double as ground and power buses of a parallel-connected photovoltaic installation, similar to the system shown in FIG. 1D. Input terminals 106 may be coupled to the outputs of a photovoltaic system. Output conductor 105a may be coupled to the power bus using a T-connector, and output conductor 105b may be coupled to the ground bus using a T-connector. The input terminals 106 and output conductors 105a, 105b are denoted explicitly in FIG. 4B only for power device 104a, to reduce visual noise. One or more power device 104a-c may comprise a DC/DC converter or DC/AC inverter configured to output a DC or AC voltage common to all parallel-connected devices. In some embodiments, one or more power device 104a-c may comprise a Maximum Power Point Tracking (MPPT) circuit with a controller, configured to extract maximum power from the PV generator the power device is coupled to. One or more power device 104a-c may further comprise a control device such as a microprocessor, Digital Signal Processor (DSP) and/or an FPGA. In some embodiments, one or more power device 104a-c may comprise circuitry and/or sensors configured to measure parameters on or near the photovoltaic generator, such as the voltage and/or current output by the generator power output by the generator, the irradiance received by the generator and/or the temperature on or near the generator. The power device chain 104 in the illustrative embodiment shown in FIG. 4B may include two long conductors, ground bus 116 and power bus 115, with PV power devices coupled to the two conductors, with the distance between adjacent power devices enabling them to be coupled to adjacent PV generators in a photovoltaic installation. The power devices may be coupled to the conductors at the time of manufacturing, and may be compactly stored along with the conductors, enabling fast and easy deployment.

Referring now to FIG. 4C, illustrative embodiments of photovoltaic power device 107 may feature an open casing or lid 232 instead of a closed casing such as casing 231 depicted in FIG. 2A. Lid 232 may include circuit-mounting surface 233 which may be used to mount circuitry 230. Circuitry 230 may comprise any and/or all of the components described herein with reference to other figures. For example, circuitry 230 may comprise a power converter such as a DC/DC or a DC/AC converter. As another example, circuitry 230 may comprise a monitoring device in addition to or instead of a power converter. In some embodiments, power device 107 may be designed to be connectable to a portion of a photovoltaic panel junction box, enabling circuitry 230 to be coupled directly to the electronics located in the panel's junction box. In some embodiments, PV power device 107 may comprise bypass and/or blocking diodes to prevent and alleviate mismatch effects in the solar arrays comprising the PV panel. In some embodiments, direct coupling of the lid to a photovoltaic generator junction box may render external input terminals unnecessary. Output conductors 234a-b may be located on opposite sides of lid 232, and may be coupled to additional power devices (not depicted explicitly in the figure), forming a chain of serially connected devices. Similar to other illustrative embodiments, the distance (i.e. the length of the coupling conductor) between adjacent power devices 107 may be of appropriate length enabling coupling of adjacent power devices to adjacent photovoltaic modules in a photovoltaic installation. The power devices may be coupled to the conductors at the time of manufacturing, and may be compactly stored along with the conductors, enabling fast and easy deployment.

Reference is now made to FIG. 5A, which depicts a portion of a chain of power devices coupled to photovoltaic generators, according to illustrative embodiments. PV generator 101e may include junction box 601e, featuring two outputs which may be coupled to input terminals 210q and 210r of power device 102e. Power generated by the PV generator may be transferred via the junction box to the power device via the input terminals 210q and 210r, which may be coupled directly to the junction box. Power device 102e may further include circuitry 230 (not explicitly depicted in the figure) which may comprise various elements as described herein. Output conductor 220e may couple power device 102e to an adjacent power device on one side (not shown explicitly), while output conductor 220f may couple power device 102e to an adjacent power device 102f on the other side, with output conductor 220f coupling power device 102f to power device 102g. To reduce visual noise, the input terminals and output conductors of power devices 102f, 102g are not labeled explicitly in the figure. Conductors 220e, 220f and 220g may be of appropriate length to enable fast and easy coupling of each of the power devices to their respective generators, without overuse of conductive cables. For example, if PV modules 101e, 101f and 101g are of standard width of 39 inches and are placed next to one another while oriented vertically, each output conductor may be about 40-45 inches long.

Reference is now made to FIG. 5B, which depicts a portion of a chain of power devices coupled to photovoltaic generators, according to illustrative embodiments. PV generator 101a may include junction box 601a, to which generator cables 501a and 501b are coupled. Power generated by the PV generator is transferred via the junction box to the generator cables, with cable 501a coupled to input terminal 210b of power device 102a, and cable 501b coupled to input terminal 210c of power device 102b. Power devices 102a and 102b may be coupled to one another by output conductor 220b. Power device 102a may include circuitry 230 (not explicitly depicted in the figure) which may comprise various elements as described herein. Output conductor 220a may couple power device 102a to an adjacent power device on one side (not shown explicitly), with input terminal 210a being coupled to an adjacent power cable (also not shown explicitly). To reduce visual noise, the input terminals and output conductors of power devices 102b, 102c are not labeled explicitly in the figure. Conductors 220a, 220b and 220c may be of appropriate length to enable fast and easy coupling of each of the power devices to two adjacent photovoltaic modules, without overuse of conductive cables. For example, if PV generators 101a 101b and 101c are of standard width of 39 inches and are placed next to one another while oriented vertically, each output conductor may be about 40-45 inches long.

Referring to FIG. 5C, illustrative embodiments may include a plurality of PV power devices 104a-c, each featuring two input terminals 106 (only labeled explicitly for power device 104a) coupled to a photovoltaic generator's junction box (e.g., 601a). The photovoltaic power may flow via the junction box and input terminals to the PV power device. The power device may include output conductor 105a, which is coupled via a T-connector to a ground bus, and output conductor 105b, which is coupled via a T-connector to a power bus. The ground bus and power bus may be coupled to the output conductors of each power device in the chain, thus coupling all the photovoltaic modules in the string in parallel. The distance between adjacent PV power devices may enable them to be coupled to adjacent PV generators in a photovoltaic installation. The power devices may be coupled to the two conductors (the ground and power buses) at the time of manufacturing, and may be compactly stored along with the conductors, enabling fast and easy deployment.

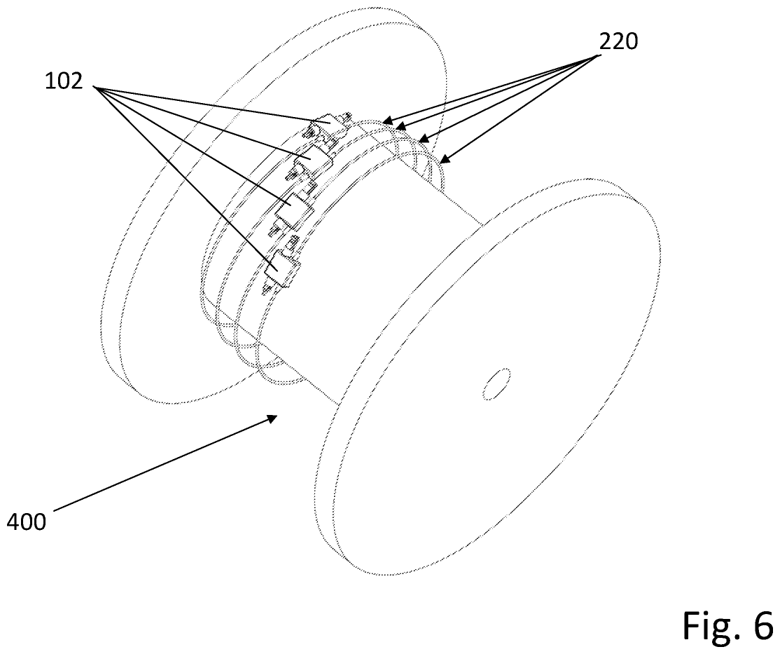

Referring now to FIG. 6, some illustrative embodiments include a storage device

used to store a chain of power devices in a way that enables convenient storing and fast and easy deployment of the chain of power devices. A chain of photovoltaic power devices may comprise PV power devices 102 coupled to one another by output conductors 220. The chain may be stored by being wound around storage device 400. In the illustrative embodiment depicted in FIG. 6, storage device 400 is a cylindrical reel, though other shapes may be using for winding. A cylindrical shape may make deployment easier, as a cylindrical reel may be rolled along the ground in a photovoltaic installation, much like cabling reels. The storage device may be designed to allow the chain of power devices to be packaged efficiently. For example, if the storage device is similar to the cylindrical reel depicted in FIG. 4, the diameter of the reel may be chosen considering the length of the conductors coupling the power devices, so that when the chain is wound around the reel, the power devices may be located next to one another on the reel, pressed tightly together for compact storing.

In some embodiments, an apparatus includes a plurality of power devices and a plurality of photovoltaic generators connected to the power devices. The power devices may include an input terminal, a common terminal and first and second output terminals. An input terminal of a first power device may be connected to a first power source terminal of one of the plurality of photovoltaic generators, a first output terminal of a second power device may be connected to a second power source terminal of one of the plurality of photovoltaic generators, and a second output terminal of the second power device may be connected to a common terminal of the first power device. The first and second output terminals may output a common output voltage, with a total output current flowing through the power device (e.g. a photovoltaic string current where the power device is part of a photovoltaic string) being divided between a first output current flowing through the first output terminal and a second output current flowing through the second output terminal. The first output current may further flow through a connected photovoltaic generator, and in some embodiments, the power device may be operated to provide a first output current corresponding to a Maximum Power Point current of the photovoltaic generator. The power device may be operated to provide a second output current corresponding to a differential current between the total output current and the first output current.

In some embodiments, the first output terminal may comprise a connector designed to be connected to a photovoltaic generator terminal, for example, using an MC4™ connector. In some embodiment, the second output terminal and the common terminal may comprise conductors preconnected to the power device and other power devices (e.g. conductors 220c and 220d of FIG. 2A, or conductors 220a and 220b of FIG. 2B). Dividing the current of a power device into two or more portions may create smaller current portions that allow for cables which may be thinner and cheaper than those which would otherwise be needed.

At least one of the power devices may include a combiner box configured to couple to a plurality of photovoltaic strings and to combine power from the plurality of photovoltaic strings. One or more power devices may include one or more sensors or sensor interfaces configured to measure or to receive measurements of one or more parameters associated with the plurality of photovoltaic generators. One or more power devices may include one or more safety switches configured to disconnect and/or short circuit the photovoltaic generators upon detection of a predefined potentially unsafe condition or in response to a manual trigger. The manual trigger may include activation of a rapid-shutdown switch or button.

In some embodiments, the power device may include output conductors configured to transmit and/or receive PLC signals. A communications link (e.g. may be integrated with output conductors and may be communicatively coupled to a communication device. A thermal sensor device may be integrated with output conductors and may provide temperature measurements to a control device associated with the apparatus. The thermal sensor device may include a thermocouple device and/or a linear heat detector. Temperature measurements by the thermal sensor device may be obtained at one or more locations along the output conductors.

In some embodiments, an apparatus includes a plurality of power devices and a plurality of conductors connecting, each connecting one power device to at least one other power device. A first conductor may be connected between an input of a first power device and a first output of a first power generator. A second conductor may be connected between an output of the first power device and a second output of first power generator. A third conductor may be connected between an output of a second power device and the common terminal of the first power device. The conductors may be internally connected to circuitry inside a respective power device. At least one of the plurality of conductors may, at a first end, be soldered or connected via a screw to the power device. A second end of the conductor may be soldered or connected via a screw to another power device. Specifically, the first end and second end may each be connected to a power converter or monitoring device in a respective power device.

Other embodiments may consider alternative storage techniques, such as packing power device chains into boxes, winding the chain around multiple poles, and the like.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof. Further, elements of one embodiment may be combined with elements from other embodiments in appropriate combinations or subcombinations. For example, conductors 234a-b of FIG. 4C may be located at a same side of lid 232, similarly to as shown with regard to terminals 210c and 210d of FIG. 2A. As another example, a chain of power devices may connect a plurality of photovoltaic generators in parallel, as shown in FIG. 5C, wherein each of the plurality of photovoltaic generators comprises a plurality of serially connected photovoltaic panels (as shown in FIG. 1E) or photovoltaic cells.

In illustrative embodiments disclosed herein, photovoltaic generators are used as examples of power sources which may make use of the novel features disclosed. Each PV generator may comprise one or more solar cells, one or more solar cell strings, one or more solar panels, one or more solar shingles, or combinations thereof. In some embodiments, the power sources may include batteries, flywheels, wind or hydroelectric turbines, fuel cells or other energy sources in addition to or instead of photovoltaic panels. Systems, apparatuses and methods disclosed herein which use PV generators may be equally applicable to alternative systems using additional power sources, and these alternative systems are included in embodiments disclosed herein.

What is claimed is:

1. An apparatus comprising:
a chain of power devices, each power device of the chain of power devices comprising:
two inputs configured to couple to a respective power source,
a first output coupled to a first conductor, and
a second output coupled to a second conductor,
wherein outputs of adjacent power devices, of the chain of power devices, are connected to each other via direct connections to respective conductors therebetween, and
wherein, for each power device of the chain of power devices:
at least one of the first conductor or the second conductor is coupled to an adjacent power device in the chain of power device, and
lengths of the first conductor and the second conductor are determined during manufacturing of the apparatus to allow coupling of each power device, of the chain of power devices, to a respective power source.

2. The apparatus of claim 1, wherein, for each power device of the chain of power devices, the first conductor and the second conductor are internally connected to circuitry inside a respective power device.

3. The apparatus of claim 1, wherein, for each power device of the chain of power devices, the first conductor and the second conductor are connected between adjacent power devices, of the chain of power devices, during manufacturing of the apparatus without use of external connectors.

4. The apparatus of claim 1, wherein each power device of the chain of power devices has a total of two connection points.

5. The apparatus of claim 1, wherein, for each power device of the chain of power devices, at least one of the first conductor and the second conductor is soldered or connected via a screw to a respective power device.

6. The apparatus of claim 1, wherein each power device of the chain of power devices comprises at least one of a direct current to direct current (DC/DC) converter or a direct current to alternating current (DC/AC) converter.

7. The apparatus of claim 1, wherein one or more power devices of the chain of power devices are configured to output a time-varying direct current (DC) signal that emulates a rectified sine wave.

8. The apparatus of claim 1, wherein one or more power devices of the chain of power devices are configured to regulate an output of one or more power generators coupled to the one or more power devices.

9. The apparatus of claim 1, wherein one or more power devices of the chain of power devices further comprise at least one of: a communication device, a residual current device, a fuse, a measuring device, or a monitoring device.

10. The apparatus of claim 1, further comprising:
a packaging assembly configured to store the chain of power devices.

11. A method comprising:
connecting, during manufacturing of a plurality of power devices, the plurality of power devices to each other by directly connecting conductors therebetween to form a chain of power devices;
connecting outputs of adjacent power devices, of the plurality of power devices, to each other by directly connecting conductors therebetween to form a chain of power devices; and
connecting two inputs, of each power device of the plurality of power devices, to a respective power source,
wherein each power device of the plurality of power devices comprises:
a first output coupled to a first conductor, and
a second output coupled to a second conductor,
wherein, for each power device of the plurality of power devices:
at least one of the first conductor or the second conductor is coupled to an adjacent power device in the chain of power devices, and
lengths of the first conductor and the second conductor are determined during manufacturing of the plurality of power devices to allow coupling of each power device, of the plurality of power devices, to a respective power source.

12. The method of claim 11, wherein, for each power device of the plurality of power devices, the first conductor and the second conductor are directly connected by soldering or screwing the conductors into place within a power device enclosure.

13. The method of claim 11, wherein the connecting the two inputs comprises:
connecting the two inputs, of each power device of the plurality of power devices, to the outputs of the respective power source.

14. The method of claim 11, wherein, for each power device of the plurality of power devices:
the first conductor and the second conductor are internally connected to circuitry inside the respective power device,
the first conductor and the second conductor are connected between adjacent power devices, of the chain of power devices during manufacturing of the apparatus without use of external connectors, and
each power device of the plurality of power devices has a total of two connection points.

15. The method of claim 11, wherein each power device of the plurality of power devices comprises at least one of a direct current to direct current (DC/DC) converter or a direct current to alternating current (DC/AC) converter.

16. The method of claim 11, wherein one or more power devices of the plurality of power devices are configured to output a time-varying direct current (DC) signal that emulates a rectified sine wave.

17. The method of claim 11, wherein one or more power devices of the plurality of power devices are configured to regulate an output of one or more power generators coupled to the one or more power devices.

18. The method of claim 11, wherein one or more power devices of the plurality of power devices further comprise at least one of: a communication device, a residual current device, a fuse, a measuring device, or a monitoring device.

19. The method of claim 11, further comprising:
storing the chain of power devices using a packaging assembly.
